(19) United States
(12) Patent Application Publication
(10) Pub. No.: US 2008/0278269 A1
(43) Pub. Date: Nov. 13, 2008

(54) System and Method for an Information Handling System Articulated Magnetic Latch

(76) Inventors: Ernesto Ramirez, Austin, TX (US); Kevin Mundt, Austin, TX (US)

Correspondence Address: HAMILTON & TERRILE, LLP, P.O. BOX 203518, AUSTIN, TX, 78720, US

(21) Appl. No.: 11/746,939

(22) Filed: May 10, 2007

(51) Int. Cl. H01H 9/00

(52) U.S. Cl. 335/205

(57) ABSTRACT

A magnetic latching system selectively couples and releases an information handling system housing and lid by moving a magnet associated with one of the housing or lid relative to a ferrous metal in the other of the housing or lid to selectively apply magnetic attraction between the housing and lid. A latch retainer interfaced with the magnetic latching system retains the magnetic latch in a released position until the lid and housing approach a closed position and then allows the magnetic latch to return to a locked position, thus bringing the lid and housing to a securely closed configuration without slamming together due to the magnetic attraction between the magnet and ferrous metal.

### BACKGROUND OF THE INVENTION

1. Field of the Invention

The present invention relates in general to the field of information handling system housings, and more particularly to a system and method for an information handling system articulated magnetic latch.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Active information handling system users have migrated from desktop systems to portable systems. Portable information handling systems generally include an integrated display to present visual information and an integrated power supply to power the system while mobile. A typical portable information handling system display integrates a flat panel liquid crystal display (LCD) in a rotationally hinged lid. The lid rotates between an open position providing access to a keyboard and a closed position providing a compact form for improved end user mobility. Generally, the closed lid is held in place by a latch that articulates to release the lid when desired by the end user. When the end user desires to have increased mobility, rotating the lid to a closed position automatically engages the latch to secure the lid in the closed position. Often, engagement of the latch in the closed position is used as an indicator by the system to enter into an ACPI standby state. A portable information handling system that was placed in a standby state by closing the lid often recovers to “on” when the lid is open. For example, opening and closing the lid is tracked with a Hall effect switch that activates power consumption control states through the chipset and BIOS.

One difficulty faced by information handling system manufacturers is to secure and release a lid and a portable information handling system housing in an aesthetically pleasing yet reliable manner. One common latching system uses “cobra fangs” that extend outward from the lid and align to enter holes in the housing. A latch biased to a locked position articulates to an unlocked position so that the “fangs” engage and disengage a retaining portion within the housing holes. Although effective and reliable, this arrangement is not generally considered aesthetically pleasing. Another system for selectively engaging a lid to a housing uses detent hinges that lock with detents when the lid is in the closed position. Although detent hinges lock and release without the use of an articulating latch, thus offering a more aesthetically pleasing solution, portable information handling systems having larger displays tend to have reliability problems with detent hinges. Another system for selectively engaging a lid to a housing uses a magnet to hold the lid and housing together. However, magnetic latches have a tendency to use magnets that are either too weak or too strong. Weak magnetic latches can result in display damage if the lid opens inadvertently, such as while stored in a carrying case, to allow objects to lodge between the lid and the housing. Overly strong magnetic latches are annoying where they require two hands to separate the lid and housing or where pulling on a lid results in the lifting of the entire system from a resting position.

### SUMMARY OF THE INVENTION

Therefore a need has arisen for a system and method which selectively moderates magnetic attraction between an information handling system lid and housing to secure or release the lid and housing.

In accordance with the present invention, a system and method are provided which substantially reduce the disadvantages and problems associated with previous methods and systems for selectively securing or releasing an information handling system lid and housing. A latch having a magnet portion and opposing ferrous portion disposed in an information handling system lid and housing selectively secures the lid and housing in a closed position with magnetic attraction or releases the lid and housing for rotation to an open position. In the closed position, the magnet and ferrous portions have a locked position of substantial alignment with sufficient proximity to keep the lid and housing together. For movement to the open position, the magnet and ferrous portion are moved relative to each other to reduce the magnetic attraction and allow movement of the lid relative to the housing.

More specifically, a magnetic latch has a magnet portion and ferrous portion that move relative to each other to selectively generate magnetic attraction for securing or releasing an information handling system lid and housing. The ferrous portion or magnetic portion is moved by user interaction with a user interface, such as movement perpendicular to the rotation of the lid and housing or movement in the direction of the lid and housing. In order to avoid slamming of the lid to the housing during closing of the lid, a latch retainer maintains the magnetic latch in a released position having minimal magnetic attraction until the lid is substantially closed and then allows the magnetic latch to go to the locked position to secure the lid and housing. A retainer coupled to the user interface maintains the user interface in the released position until the lid approaches closure relative to the housing. As the lid substantially closes relative to the housing, a magnet associated with the retainer interacts with a magnet or ferrous portion disposed in the housing to release the retainer and allow the user interface to move to the locked position. Because movement of the magnetic latch to the locked position is delayed until the lid is substantially closed, the force of the magnetic attraction does not operate to slam the lid to the housing.

The present invention provides a number of important technical advantages. One example of an important technical advantage is that an aesthetically-pleasing and reliable magnetic latch secures an information handling system lid to a housing in a closed position yet moves to an open position with relatively little force. The magnetic latch automatically secures the lid to the housing without excessive force during closing by maintaining the magnetic latch in a released position until the lid is substantially closed. The articulation latch moves either horizontally or vertically to release the lid from the housing to provide a natural end user interaction.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts an information handling system having a magnetic latch;

FIG. 2 depicts an information handling system housing and lid in a closed position secured by a magnetic latch in a locked position;

FIG. 3A depicts an information handling system housing and lid in a closed position with a magnetic latch in a vertical released position having a magnet portion moved distal the ferrous portion in the direction of rotation of the lid relative to the housing;

FIG. 3B depicts an information handling system housing and lid in a closed position with a magnetic latch in a horizontal released position having a magnet portion moved distal the ferrous portion perpendicular to the direction of rotation of the lid relative to the housing;

FIG. 3C depicts an information handling system housing and lid in a closed position with a magnetic latch in a vertical released position so that a magnetic portion and release magnet align to bias the lid from the housing;

FIG. 4A depicts a magnetic latch having a latch retainer with opposing magnets; and

FIG. 4B depicts a magnetic latch having a latch retainer with a magnet and opposing ferrous portion.

### DETAILED DESCRIPTION

A magnetic latch selectively secures and releases an information handling system housing and lid. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

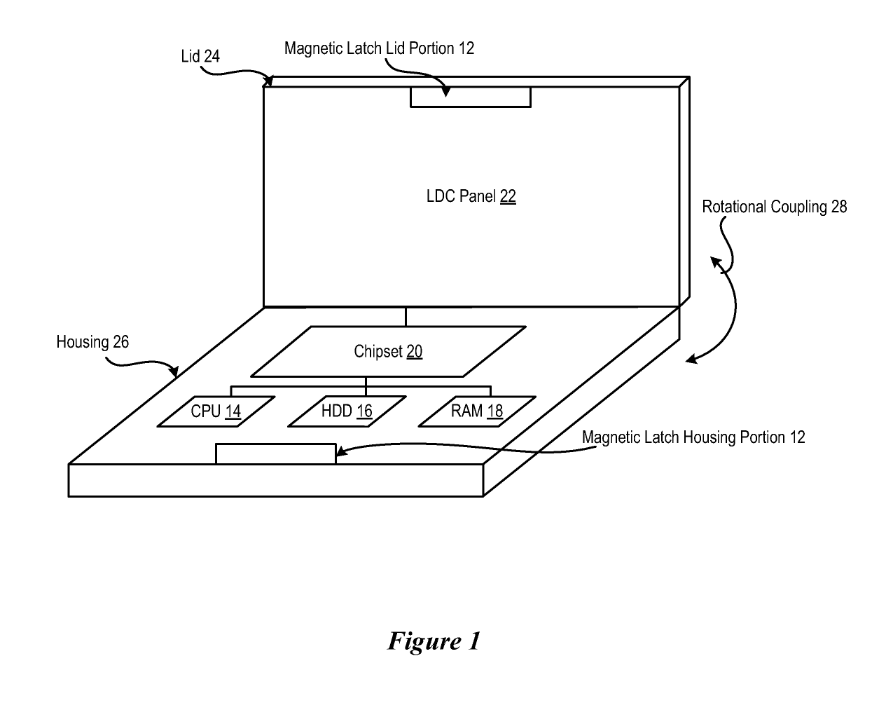

Referring now to FIG. 1, an information handling system 10 having a magnetic latch 12 is depicted. Information handling system 10 has plural processing components that cooperate to process information, such as a CPU 14, RAM 16, a hard disk drive 18, and chipset 20. Chipset 20 has graphical processing capability to process information for presentation at an LCD panel 22. LCD panel 22 is integrated in a lid 24 that is rotationally coupled to a housing 26. Lid 24 rotates as depicted by rotational coupling arrows 28 between the depicted open position and a closed position in which the lid covers the upper face of housing 12. Magnetic latch 12 includes a portion in lid 24 and a portion in housing 26 that interact to selectively secure lid 24 to housing 26 in the closed position and selectively release lid 24 to rotate relative to housing 26.

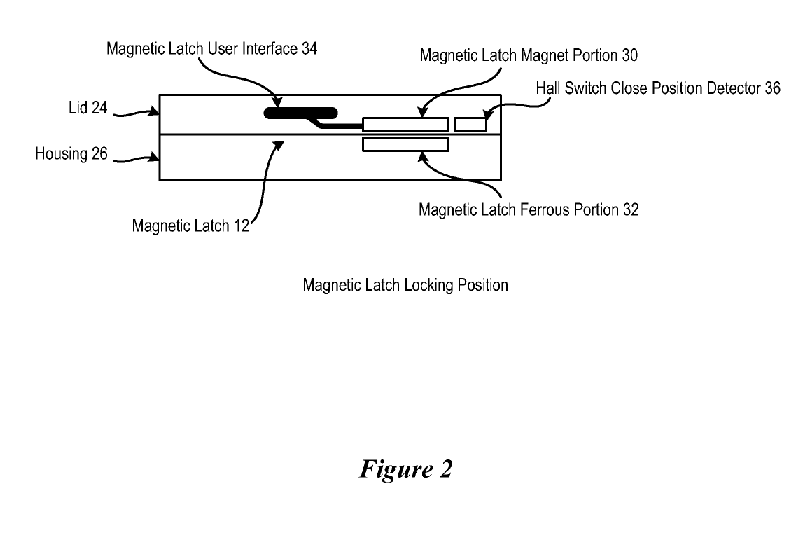

Referring now to FIG. 2, an information handling system housing 26 and lid 24 are depicted in a closed position secured by a magnetic latch 12 in a locked position. Magnetic latch 12 has a magnetic portion 30 disposed in lid 24 and a ferrous portion 32 disposed in housing 26. A user interface 34 couples to magnetic portion 30 to allow an end user to move magnetic portion 30 relative to ferrous portion 32. In alternative embodiments, magnetic portion 30 and/or user interface 34 may be disposed in housing 26 and ferrous portion 32 may be disposed in lid 24. Magnetic portion 30 and ferrous portion 32 have sufficient magnetic attraction so that, when placed in proximity to each other, lid 24 and housing 26 are securely held together. However, the magnetic attraction decreases logarithmically when magnetic portion 30 and ferrous portion 32 are moved relative to each other to have increased distance between each other so that lid 24 and housing 26 are separated from each other with minimal force. The amount of magnetic attraction is selected based upon the desired securing strength of magnetic latch 12. In one embodiment, the ferrous portion is a magnet so that two magnets are used instead of a single magnet and ferrous portion. A Hall switch detects a closed position of lid 24 to housing 26, such as to place information handling system 10 in a standby state.

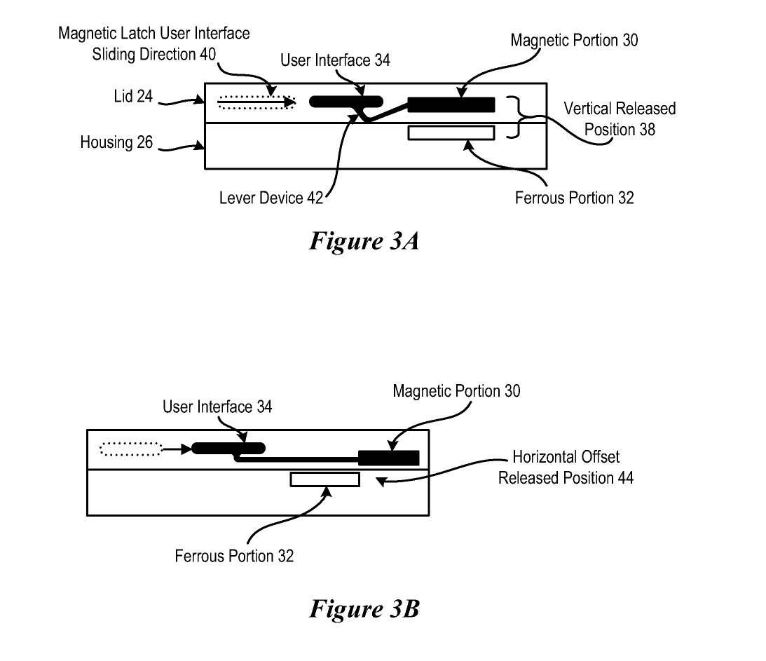

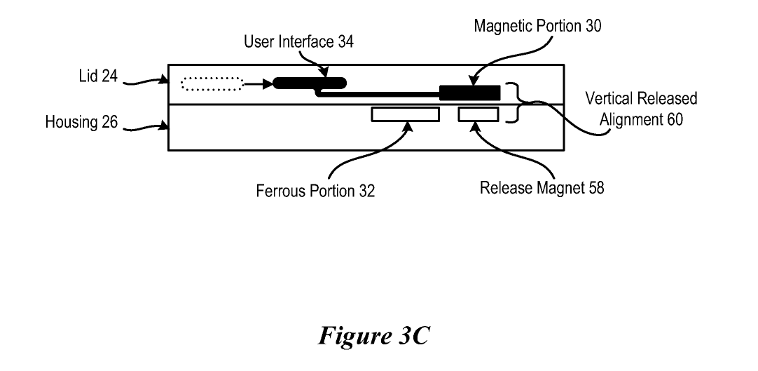

Referring now to FIG. 3A, an information handling system housing 26 and lid 24 are depicted in a closed position with a magnetic latch 12 in a vertical released position 38 having a magnet portion 30 moved distal the ferrous portion 32 in the direction of rotation of the lid relative to the housing. Movement of user interface 34 in the sliding direction 40 that is perpendicular to the direction of rotation of lid 24 activates a lever device 42 that lifts magnetic portion 30 away from ferrous portion 32, thus reducing the magnetic attraction securing lid 24 and housing 26. As an alternative, user interface 34 may move in the direction of rotation of lid 24 so that end user inputs to lift user interface 34 also work to separate lid 24 from housing 26.

Referring now to FIG. 3B, an information handling system housing 26 and lid 24 are depicted in a closed position with a magnetic latch 12 in a horizontal released position 44 having a magnet portion 30 moved distal the ferrous portion 32 perpendicular to the direction of rotation of the lid relative to the housing. In order to manage the amount of force needed to slide user interface 34, materials of varying degrees of friction may be used along the path followed by magnetic portion 30. The amount of horizontal offset may vary based upon the degree of separation needed to sufficiently reduce the attraction between lid 24 and housing 26 for the desired resistance to the opening of lid 24 by an end user. As is depicted in FIG. 3C, in addition to moving the magnetic portion 30 and ferrous portion 32 to obtain horizontal offset 44, user interface 34 might also align magnetic portion 30 with a release magnet 58 to obtain vertical release alignment 60. Release magnet 58 has a pole that is opposite the pole of magnet portion 30 so that the opposing poles repel each other. The repelling force provided by the opposing poles biases lid 24 away from housing 26 so that the lid rotates more easily from the closed to the open position.

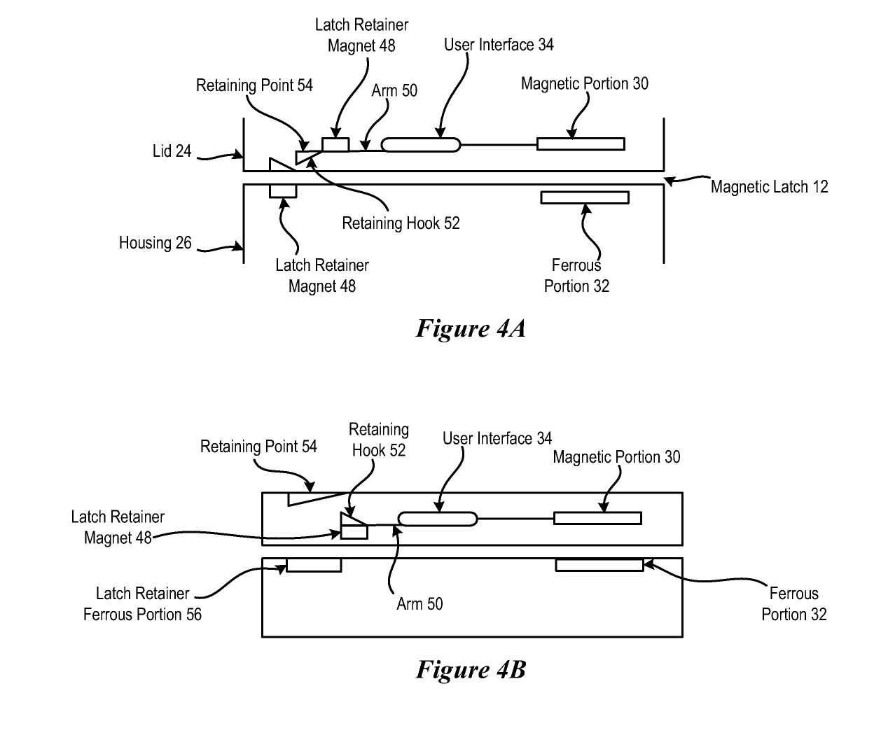

Referring now to FIG. 4A, a magnetic latch 12 having a latch retainer 46 with opposing magnets 48 is depicted. User interface 34 has an arm 50 that terminates with a retaining hook 52. A retaining point 54 is disposed in the lid along a path followed by retaining hook 52 when user interface 34 is slid to a released position in which ferrous portion 32 and magnetic portion 30 are misaligned to reduce their magnetic attraction. Movement of user interface 34 to a release position engages retaining hook 52 at retaining point 54 so that user interface 34 remains in the released position as lid 24 rotates away from housing 26. With user interface 34 in the released position, magnet portion 30 and ferrous portion 32 are misaligned so that magnetic attraction pulling lid 24 and housing 26 together is minimized. The reduced magnetic attraction prevents lid 24 and housing 26 from slamming shut as lid 24 is rotated to a closed position. However, when lid 24 reaches a predetermined closure, such as a substantially closed position where the remaining movement to full closure is too small to build adequate strength to slam shut, opposing poles of latch retainer magnets 48 forces arm 50 upwards to release retaining hook 52 from retaining point 54. Once freed from engagement of retaining hook 52, user interface 34 is biased towards a locked position by the proximity of magnetic portion 30 to ferrous portion 32. In the locked position, the magnetic attraction of magnetic portion 30 to ferrous portion 32 brings lid 24 and housing 26 together securely. Since the locked position was delayed until lid 24 was substantially closed, lid 24 and housing 26 do not have sufficient room to slam shut.

Referring now to FIG. 4B, a magnetic latch 12 having a latch retainer 46 with a magnet 48 and opposing ferrous portion 56 is depicted. In the embodiment depicted by FIG. 4B, latch retainer 46 activates by the interaction of a magnet 48 and ferrous potion 56 that are attracted towards each other as lid 24 approaches a substantially closed position, such as predetermined distance at which lid 24 and housing 26 will not slam together when magnet portion 30 and ferrous portion 32 move into alignment. As lid 24 approaches housing 26, magnet 48 is pulled toward ferrous portion 56 to release retaining hook 52 from retaining point 54. Release of retaining hook 52 allows user interface 34 to bias to a locked position so that magnet portion 30 and ferrous portion 32 secure lid 24 to housing 26.

Although the present invention has been described in detail, it should be understood that various changes, substitutions and alterations can be made hereto without departing from the spirit and scope of the invention as defined by the appended claims.

What is claimed is:

1. An information handling system comprising:
a housing;
plural processing components operable to process information;
a lid rotationally coupled to the housing and operable to rotate between an open position and a closed position;
a display disposed in the lid and interfaced with the processing components, the display operable to present the information;
a magnetic latch having a magnetic portion and a ferrous metal portion, one of the portions disposed in the housing and one of the portions disposed in the lid, the magnetic latch having a locking position with the magnetic portion and ferrous portion substantially aligned for magnetic coupling of the lid and housing to each other and having a released position with the magnetic portion and ferrous portion moved distal from each other sufficiently to substantially release the magnetic coupling.

2. The information handling system of claim 1 wherein the release position comprises movement of the portion disposed in the lid in a direction of rotation of the lid from the closed position to the open position.

3. The information handling system of claim 1 wherein the release position comprises movement of the portion disposed in the lid in a direction perpendicular to the rotation of the lid from the closed position to the open position.

4. The information handling system of claim 1 further comprising a closed position detector proximate the magnetic latch, the closed position detector operable to detect the lid in a closed position and to communicate the closed position to the processing components to initiate a standby power state.

5. The information handling system of claim 1 further comprising a latch retainer interfaced with the magnetic latch, the latch retainer engaging the magnetic latch in the released position when the lid is rotated from the closed position to the open position until the lid rotates to a substantially closed position.

6. The information handling system of claim 5 where the latch retainer comprises:
an arm extending from one portion of the magnetic latch to a retaining point, the arm positioned to engage the retaining point when the magnetic latch is placed in the released position; and
a release mechanism associated with the arm and operable to disengage the arm from the retaining point when the lid rotates from an open position to a substantially closed position.

7. The information handling system of claim 6 wherein the release mechanism comprises a first magnet disposed in the lid and a second magnet disposed in the housing opposite the first magnet, the first and second magnets having aligned opposing poles, one of the magnets coupled to the arm to push the arm from the retaining point as the lid approaches the closed position.

8. The information handling system of claim 6 wherein the release mechanism comprises a magnet disposed in the lid and a ferrous metal disposed in the housing opposite the magnet, magnet coupled to the arm to pull the arm from the retaining point as the lid approaches the closed position.

9. A method for selectively securing and releasing an information handling system housing and rotationally coupled lid, the method comprising:
disposing a magnet in one of the housing or the lid;
disposing a ferrous metal material in the other of the housing or the lid to align with the magnet, a magnetic attraction between the magnet and the ferrous metal material securing the lid to the housing in a closed position;
moving one of the magnet or the ferrous metal material relative to the other to reduce the magnetic attraction; and
rotating the lid relative to the housing to an open position.

10. The method of claim 9 wherein moving one of the magnet or the ferrous material further comprises moving the one of the magnet or ferrous material disposed in the lid in the direction of rotation of the lid.

11. The method of claim 9 wherein moving one of the magnet or the ferrous material further comprises moving the one of the magnet or ferrous material disposed in the lid perpendicular to the direction of rotation of the lid.

12. The method of claim 9 further comprising:
detecting the lid in the closed position; and
communicating the closed position to processing components in the information handling system housing; and
applying the closed position to enter a powered down state.

13. The method of claim 9 further comprising:
retaining the one of the magnet or ferrous material in the moved position associated with the reduced magnetic attraction;
rotating the lid relative to the housing to a closed position; and
releasing the one of the magnet or ferrous material from the moved position associated with the reduced magnetic attraction as the lid approaches the closed position to align the ferrous material and magnet.

14. The method of claim 13 wherein retaining the one of the magnet or ferrous material further comprises:
extending an arm from the one of the magnet or ferrous material, the arm having a retaining hook; and
engaging the retaining hook in a retaining point.

15. The method of claim 14 wherein releasing the one of the magnet or ferrous material from the moved position further comprises:
bringing a magnet associated with the arm proximate a ferrous material by the rotating of the lid relative to the housing to the closed position; and
moving the arm by the attraction of the magnet and the ferrous material to disengage the retaining hook from the retaining point.

16. The method of claim 14 wherein releasing the one of the magnet or ferrous material from the moved position further comprises:
bringing a first magnet associated with the arm proximate a second magnet by the rotating of the lid relative to the housing to the closed position; and
moving the arm by the repulsion of like poles of the first and second magnet to disengage the retaining hook from the retaining point.

17. A magnetic latching system for latching first and second portions, the magnetic latching system comprising:
a magnet associated with the first portion;
a ferrous material associated with the second portion;
a user interface operable to move the magnet and ferrous material relative to each other between a locking position and a released position, the locking position having the magnet and ferrous material proximate to each other to pull the first and second portions together, the released position having the magnet and ferrous material distal to each other to allow separation of the first and second portions from each other.

18. The magnetic latching system of claim 17 further comprising a latch retainer operable to retain the user interface in the released position until the first and second portions are within a predetermined distance of each other and then to release the user interface to the locked position.

19. The magnetic latching system of claim 18 wherein the latch retainer comprises:
an arm extending from the user interface and terminating with a retainer;
a retaining point positioned to align with the retainer when the user interface is in the released position; and
a biasing mechanism operable to engage the retainer and the retaining point when the first and second portions are greater than the predetermined distance and to disengage the retaining point and retainer when the first and second portions are within the predetermined distance.

20. The magnetic latching system of claim 17 wherein the ferrous portion comprises a magnet.

21. The magnetic latching system of claim 17 further comprising a release magnet associated with the second portion, the release magnet and the magnet associated with the first portion having opposing poles, the release magnet aligned with the magnet associated with the first portion when the user interface is in the released position to repel the first and second portions apart from each other.
